(19) United States
(12) Patent Application Publication
(10) Pub. No.: US 2011/0168015 A1
(43) Pub. Date: Jul. 14, 2011

(54) ETHYLENE-ACRYLIC BONDED PISTON WITHOUT OVEN POST CURING

(76) Inventor: Samuel Roger Holliday, JR., Ann Arbor, MI (US)

(21) Appl. No.: 12/986,543

(22) Filed: Jan. 7, 2011

Related U.S. Application Data
(60) Provisional application No. 61/293,307, filed on Jan. 8, 2010.

(51) Int. Cl. F16J 1/01; B32B 37/02

(52) U.S. Cl. 92/249; 156/60

(57) ABSTRACT

A piston for an automatic transmission includes a cylindrical portion formed of a steel material and an elastomer bonded thereto. The elastomer includes an ethylene-acrylic polymer, a filler, and a hexamethylene diamine curing agent. The elastomer is compression or injection molded to the metal cylindrical portion. During the molding step, the elastomer is cured and achieves a cross-link density, strength, and other physical properties sufficient for use in an automatic transmission. Thus, the piston is formed without a post curing step. The piston provides a lower wear rate and a higher life expectancy than pistons formed with a post curing step.

### CROSS-REFERENCE TO RELATED PATENT APPLICATIONS

This application claims priority to U.S. Provisional Patent Application Ser. No. 61/293,307, filed on Jan. 8, 2010, and is incorporated herein by reference.

### BACKGROUND OF THE INVENTION

1. Field of the Invention

The present invention relates to an elastomer suitable for coupling to a metal material of an automatic transmission piston, and a method of manufacturing the same.

2. Description of the Prior Art

Automatic transmission pistons are typically used to hydraulically engage and activate clutches, gearshifts, brake bands, and to perform other mechanical operations. Automatic transmission pistons must be strong, reliable, and have a long service life because failure of such a piston can lead to failure of the entire transmission. Therefore, a rubber or elastomer ring is often disposed around a metal component of the piston for sealing fluid between the piston and a cylinder or shaft along which the piston travels. The elastomer seals provide high resistance to frictional wear for improved service life and contribute to the overall strength of the piston.

An existing automatic transmission piston having excellent strength, reliability, and service life is Federal-Mogul's UNIPISTON®, which is single piece, bonded, and sealed. The single piece design provides a reduced number of leak paths, improved reliability, and a more compact design, compared to multi-piece designs. However, the process of forming the automatic transmission piston requires significant time and manufacturing costs. The process typically includes forming a metal base, preparing an elastomer, compression or injection molding the elastomer to the metal base, oven post curing the piston, and various other steps. The numerous process steps, time, and related manufacturing costs hinder the production of reliable automatic transmission pistons.

### SUMMARY OF THE INVENTION

One aspect of the invention provides a piston for use in an automatic transmission, comprising a cylindrical portion formed of a metal material and an elastomer coupled to the cylindrical portion. The elastomer includes an ethylene-acrylic polymer in an amount of 25 wt. % to 75 wt. % and a curing agent in an amount of at least 0.5 wt. %, based on the total weight of the elastomer. The ethylene-acrylic polymer includes methyl acrylate in an amount of 40 wt. % to 70 wt. % and an ethylene monomer in an amount of 20 wt. % to 60 wt. %, based on the total weight of the ethylene-acrylic polymer. The elastomer is cured by exposing the elastomer to a temperature of at least 100° C. continuously for a single period of time. The elastomer is cured without exposing the elastomer to a temperature of at least 100° C. continuously for a second period of time.

The present invention is also directed towards a method of forming the piston. The method includes providing an elastomer including an ethylene-acrylic polymer in an amount of 25 wt. % to 75 wt. % and a curing agent in an amount of at least 0.5 wt. %, based on the total weight of the elastomer, wherein the ethylene-acrylic polymer includes methyl acrylate in an amount of 40 wt. % to 70 wt. % and ethylene monomer in an amount of 20 wt. % to 60 wt. %, based on the total weight of the ethylene-acrylic polymer. The method next includes coupling the elastomer to a cylindrical portion formed of a metal material. The coupling step includes curing the elastomer. The curing step includes exposing the elastomer to a temperature of at least 100° C. continuously for a single period of time. The piston is formed without exposing the elastomer to a temperature of at least 100° C. continuously for a second period of time.

The single-piece bonded piston is formed without an oven post curing step, which includes the step of exposing the elastomer to a temperature of at least 100° C. continuously for a second period of time, after coupling the elastomer to the cylindrical portion. During the step of coupling the elastomer to the cylindrical portion, sufficient cross-linking of the elastomer occurs to provide strength, heat resistance, and other physical properties suitable for use of the piston in an automatic transmission application, for example to hydraulically engage clutches to activate a gearshift. The elastomer formed without an oven post curing step provides a lower wear rate and a greater life expectancy than comparative elastomers, which are formed with a post curing step.

The method of forming the piston provides significant manufacturing cost savings, compared to other methods of forming single-piece bonded pistons that require a post curing step. The method also provides a reduced environmental footprint, including a significant reduction in CO₂ emissions and natural gas consumption, compared to method including a post curing step.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a piston of a first embodiment;

FIG. 2 is an enlarged fragmentary cross sectional view of the piston of FIG. 1 taken along line 2-2.

FIG. 3 is a perspective view of a piston of a second embodiment; and

FIG. 4 is a perspective view of a piston of a second embodiment.

### DETAILED DESCRIPTION OF THE INVENTION

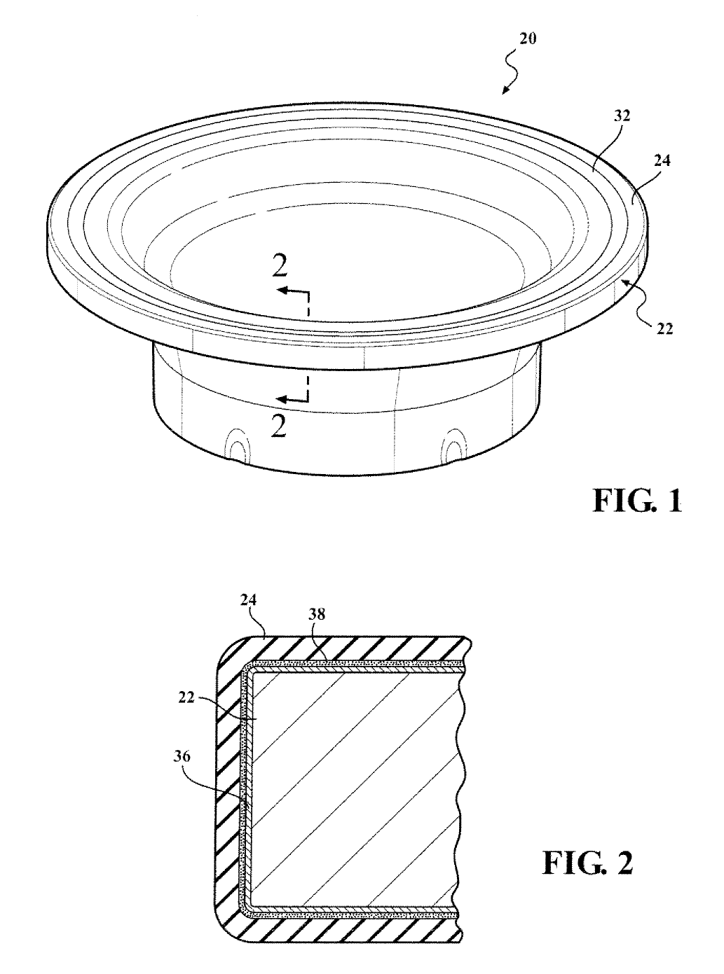

An exemplary piston 20 for an automatic transmission includes a cylindrical portion 22 formed of a metal material and an elastomer 24 coupled to the cylindrical portion 22 is shown in FIG. 1. The method of manufacturing the piston 20 includes coupling the elastomer to the cylindrical portion 22 without a post curing step.

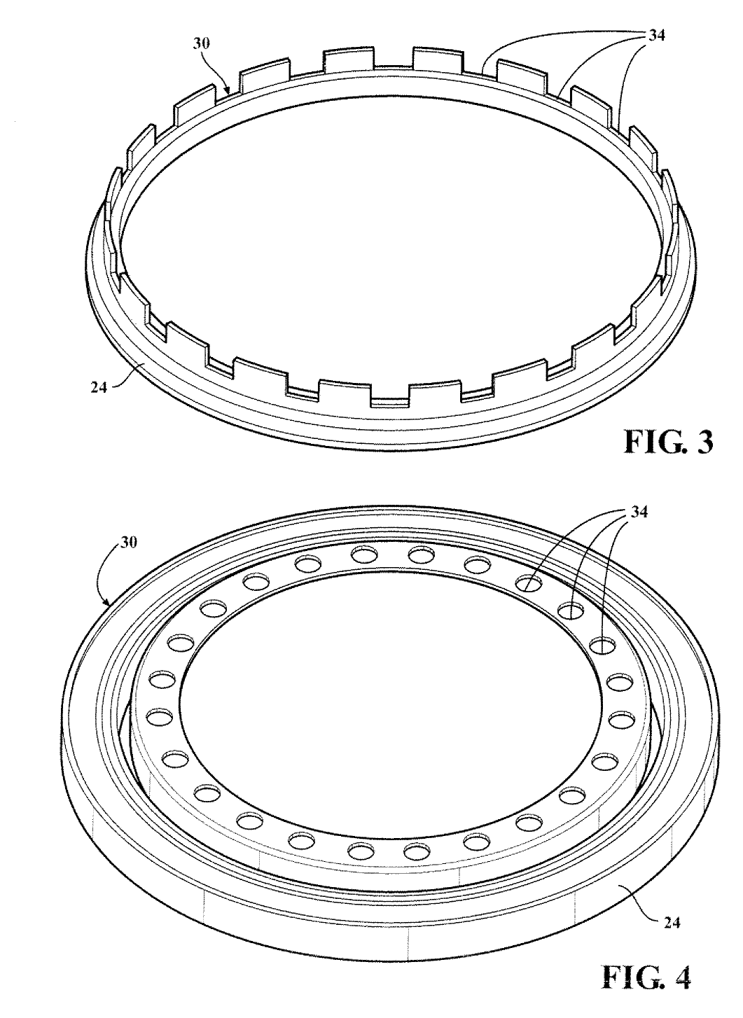

The cylindrical portion 22 of the piston 20 is formed of a metal material, such as Steel 1010. The cylindrical portion 22 can also be formed of other types of steel, aluminum, an aluminum alloy, or another metal material. The cylindrical portion 22 of the piston 20 can include a crown 26 and skirt 28 encompassing a center opening, as shown in FIG. 1. The cylindrical portion 22 can also include a cylindrical ring 30, as shown in FIGS. 3 and 4, or other designs suitable for an automatic transmission system. The cylindrical portion 22 typically includes a top surface, an inner surface, and an outer surface.

The cylindrical portion 22 can include at least one groove 32 formed therein, as shown in FIG. 1, which can be used to direct lubricating oil or hydraulic fluid to predetermined locations, or for other purposes. The groove 32 of the cylindrical portion 22 can extend axially into and around the circumference of the piston 20. The cylindrical portion 22 can include at least one of the grooves 32 extending radially into the piston 20, or a plurality of grooves 32 extending axially into the piston 20 and spaced from one another around the circumference of the piston 20. The cylindrical portion 22 can also include at least one cutout 34 formed therein. For example, the cylindrical portion 22 can include a plurality of the cutouts 34 extending axially into the piston 20 and spaced from one another around the circumference of the piston 20, as shown in FIG. 4. The cutouts 34 can also extend radially into the piston 20, as shown in FIG. 3.

The cylindrical portion 22 can be coated with a conversion coating 36, such as a calcium-modified zinc phosphate conversion coating, as shown in FIG. 2. The conversion coating provides some surface roughness and increases the surface area of the metal cylindrical portion 22. An adhesive 38, such as organosilane coupling agent, can be disposed on the conversion coating, as shown in FIG. 2. The conversion coating helps carry the adhesive on the metal cylindrical portion 22 and allows for some mechanical interlocking between the elastomer and the metal cylindrical portion 22.

The elastomer is coupled to the cylindrical portion 22 of the piston 20, typically around the circumference of the cylindrical portion 22. The elastomer can be disposed on the cylindrical portion 22 and over the adhesive and the conversion coating. The elastomer can be coupled to the outer surface, inner surface, top surface, or portions of all the surfaces of the cylindrical portion 22. The elastomer is typically disposed in locations subject to high pressure, friction, and wear, and thus the location of the elastomer can change depending on the design of the cylindrical portion 22 and the specific application of the piston 20. The elastomer is coupled to the piston 20, and the piston 20 is formed without a posting cure step, which will be discussed further below.

The elastomer comprises an ethylene-acrylic polymer and a curing agent. The elastomer also typically includes fillers, several processing aids and antidegradants. The (wt. %) weight percent of each component of the elastomer is measured when the elastomer is in an un-cured state, which is before the elastomer is coupled to the metal cylindrical portion 22 of the piston 20, i.e. before compression molding, injection molding, or bonding.

The elastomer includes the ethylene-acrylic polymer in an amount of 25 wt. % to 75 wt. %, preferably 35 wt. % to 65 wt. %, and more preferably 40 wt. % to 50 wt. %, based on the total weight of the elastomer.

The ethylene-acrylic polymer can includes methyl acrylate (C₄H₆O₂), ethylene monomer C₂H₄. Preferably, the ethylene-acrylic polymer includes the methyl acrylate, the ethylene monomer, and a cure site monomer. In one embodiment, the ethylene-acrylic polymer is referred to as a terpolymer of the methyl acrylate, the ethylene monomer, and the cure site monomer. The methyl acrylate is present in an amount of 40 wt. % to 70 wt. %, or 45 wt. % to 65 wt. %, or 50 wt. % to 60 wt. %, based on the total weight of the ethylene-acrylic polymer. The ethylene monomer is present in an amount of 20 wt. % to 60 wt. %, or 25 wt. % to 55 wt. %, or 35 wt. % to 50 wt. %, based on the total weight of the ethylene-acrylic polymer. The cure site monomer is present in an amount up to 10 wt. %, or 0.1 wt. % to 8 wt. %, or 0.5 wt. % to 5 wt. %, based on the total weight of the ethylene-acrylic polymer.

The cure site monomer of the ethylene-acrylic polymer is preferably acidic. In one embodiment, the cure site monomer has the following chemical structure:

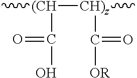

wherein X, Y, and Z are independently selected from an integer ranging from 1 to 1,000,000; and each R is independently selected from a group comprising hydrogen or a hydrocarbon chain of any length.

The elastomer includes the filer, typically carbon black, in an amount of 20 wt. % to about 70 wt. %, or 30 wt. % to 50 wt. %, or 35 wt. % to 45 wt. %, based on the total weight of the elastomer. In one preferred embodiment, the carbon black meets the ASTM D grade N550 specification.

The elastomer also includes the curing agent in an amount of at least 0.5 wt. %, or about 0.5 wt. % to 10 wt. %, or 0.5 wt. % to 5 wt. %, or 0.5 wt. % to 1 wt. %, based on the total weight of the elastomer. In one preferred embodiment, the curing agent is hexamethylene diamine, or hexamethylenediamine carbamate. Alternatively, the curing agent can include one or more another components. The curing agent is used to promote the cross-linking.

In addition to the ethylene-acrylic polymer, carbon black, and curing agent, the elastomer preferred includes additional components, such as process aids, antidegradants, accelerators, and other fillers. The additional components are typically present in a total amount up to about 25 wt. %, or 1 wt. % to 20 wt. %, or 5 wt. % to 15 wt. %, based on the total weight of the elastomer.

The process aids of the elastomer typically includes plasticizers in an amount up to about 10 wt. %. In one embodiment, the elastomer includes an ether-ester plasticizer. Other process aids often used include stearic acid in an amount of 0.3% to 2 wt. %; polyoxyethlyene octadecyl ether phosphate in an amount of 0.3% to 1 wt. %; 1-octadecanamine in an amount of 0.3 wt. % to 1 wt. %; sorbitan monstearate in an amount up to 2.5 wt. %; bis(N-butyl)Sebacate in an amount up to 4 wt. %; and a tertiary amine complex in an amount up to 2.5 wt. %, based on the total weight of the elastomer.

A preferred antidegradant of the elastomer is substituted diphenylamine antioxidant in an amount up to 2 wt. %, based on the total weight of the elastomer. A preferred filler, in addition to the carbon black, is precipitated hydrated amorphous silica in an amount up to 15 wt. %, based on the total weight of the elastomer. A preferred accelerator of the elastomer is N,N′ di-o-tolyguanidine in an amount up to about 2.5 wt. %, based on the total weight of the elastomer. Table 1 includes an exemplary composition of the elastomer.

TABLE 1

| Component | Wt. %* |
|---|---|
| Ethylene-acrylic polymer | 45.7 |
| carbon black filler (meeting the ASTM D 1765 grade | 41.2 |
| N550 specification) | |
| ether-ester plasticizer | 3.4 |
| precipitated hydrated amorphous silica | 1.4 |
| substituted diphenlylamine antioxidant | 0.9 |
| stearic acid | 0.9 |
| polyoxyethlyene octadecyl ether phosphate | 0.9 |
| 1-octadecanamine | 0.5 |
| sorbitan monstearate | 1.4 |
| N,N′ di-o-tolyguanidine | 1.8 |
| bis(n-butyl)sebacate | 1.4 |
| hexamethylenediamine carbamate | 0.9 |

*wt. % of the elastomer before coupling to the cylindrical portion 22, based on the total weight of the elastomer.

The elastomer is cured during the step of coupling the elastomer to the cylindrical portion 22, without a post curing step. The elastomer is cured by exposing the elastomer to a temperature of at least 100° C. continuously for a single period of time and is cured without exposing the elastomer to a temperature of at least 100° C. continuously for a second period of time.

After the elastomer is coupled to the piston 20 and cured, the elastomer includes amide cross-links. The amide cross-links are formed during the process of coupling the elastomer to the piston 20, such as during compression molding. The elastomer typically includes little to no imide cross-links, which would be formed during a post curing step. In one embodiment, the elastomer includes less than 5%, or less than 1% imide cross-links, based on the total amount of cross-links of the elsatomer. The cross-link composition and amount is determined immediately after coupling the elastomer to the cylindrical portion 22 and allowing the elastomer to cool to ambient temperature. The cross-link composition and amount is measured before using the piston 20 in an automotive transmission or another engine application wherein the piston 20 is exposed to high temperatures. The cross-link composition and amount is measured before using the piston 20 in an automotive transmission because additional cross-link rearrangement or formation may occur during such use of the piston 20 at the high temperatures. The amide cross-links provide the elastomer with a cross-link density and strength sufficient for use in an automatic transmission application. Since the cross-linking occurs when the elastomer is coupled to the piston 20, the cross-link composition and density is measured after the elastomer is coupled to the piston 20.

The cross-link density of the elastomer can be determined by a solvent swell test, wherein the solvent swell index of the elastomer is measured. The solvent swell test includes placing a sample of the elastomer in a solvent at a temperature of 25° C. for a period of 72 hours. The sample of the elastomer is obtained after the elastomer has been coupled to the metal cylindrical portion 22. The solvent swell index is determined by the following equation: (weight of the solvent absorbed÷weight of the elastomer sample)×100. The solvent swell index of the elastomer bonded to the piston 20 without an oven post curing step indicates the cross-link density of the elastomer is sufficient for use in an automotive application, such as an automatic transmission application. An additional post curing step does not provide a significant increase the cross-link density of the elastomer.

The piston 20 including the elastomer having the composition described above also has sufficient tensile strength, tensile modulus, and heat resistance for use in an automotive application, such as an automatic transmission application. For example, the piston 20 can be used to hydraulically engage clutches to activate gearshift.

The method of forming the piston 20 first includes providing an elastomer including an ethylene-acrylic polymer in an amount of 25 wt. % to 75 wt. %, and a curing agent in an amount of at least 0.5 wt. %, based on the total weight of the elastomer. The ethylene-acrylic polymer includes methyl acrylate in an amount of 40 wt. % to 70 wt. % and ethylene monomer in an amount of 20 wt. % to 60 wt. %, based on the total weight of the ethylene-acrylic polymer. Next, the method includes coupling the elastomer to a cylindrical portion 22 of a piston 20. The coupling occurs at a temperature of at least 100° C. to provide cross-linking in an amount sufficient for use of the elastomer in an automatic transmission engine. The elastomer is cured during the coupling step. Sufficient cross-linking and other desirable properties are achieved during the coupling step, and thus method does not include a post curing step after the elastomer is coupled to the cylindrical portion 22.

An example of the method of forming the piston 20 first includes mixing the elastomer in an internal rubber mixer, such as a Banbury mixer, or an open mill. The method typically includes two passes through the Banbury mixer. During the first pass through the mixer, the method includes setting the mixer to a speed of about 24 rpm. The method next includes adding the substituted diphenylamine antioxidant, stearic acid, ether-ester plasticizer, 1-octadecanamine, and sorbitan monstearate to the mixer while continuing to mix at about 24 rpm to form a first mixture.

Next, the ethylene-acrylic polymer, along with the carbon black are added to the first mixture and mixed at about 24 rpm. After the ethylene-acrylic polymer and carbon black are added to the mixture, the mixing speed is lowered while continuing to mix for about five minutes or until the mixture reaches a temperature of about 105° C. Next, the method includes increasing the mixing speed and sweeping the mixer.

After the mixer is swept, the method includes lowering the mixing speed while continuing to mix until the temperature reaches about 105° C. Next, the method includes adding plasticizer and silica to the first mixture while increasing the mixing speed to about 36 rpm. After increasing the mixing speed to about 36 rpm, the mixing speed is lowered again while continuing to mix for about 45 seconds. The first mixture is then lowered or dropped from the mixer onto a mill. The first mixture is rolled into sheets and stored for the second pass through the mixer and further processing.

The second pass through the mixer includes setting the mixer to a speed of about 24 rpm again and mixing one half of the first mixture from the first pass through the mixer at about 24 rpm. The method next includes adding the N,N′ di-o-tolyguanidine and the hexamethylenediamine carbamate to the first mixture to form a second mixture. After the N,N′ di-o-tolyguanidine and the hexamethylenediamine carbamate are added, the other half of the first mixture from the first pass is added to the mixer. The method next includes lowering the mixing speed while mixing the first mixture and the second mixture together for about 30 seconds to form a final mixture. The final mixture of elastomer is lowered or dropped out of the mixer, rolled into sheets, and stored in an un-vulcanized or un-cured state for further processing. Alternatively, the method of forming the elastomer includes different, additional, or fewer steps than those described above.

The elastomer may be coupled to the piston 20 by a variety of methods, but typically is coupled by a compression molding or injection molding process. The un-cured elastomer is prepared for the compression or injection molding process by first testing the elastomer for proper quality. The wt. % of each component is measured at this time. For compression molding, the method includes cutting the elastomer into pieces of suitable size and shape. The cutting is performed by an extruder equipped with a rotating knife blade on the end, or another suitable method. A batch of the elastomer is loaded into the extruder, a tube of the elastomer is extruded, and the rotating knife on the end of the extruder cuts the extruded elastomer into ring-shaped pre-forms for compression molding. Alternatively, the elastomer is cut into granules or strips for injection molding.

The cylindrical portion 22 of the piston 20 is prepared for the compression or injection molding process in parallel with the preparation of the elastomer, and may be prepared by a variety of methods. For example, the cylindrical portion 22 is formed by stamping a coil of strip steel, such as Steel 1010. Next, the stamped steel cylindrical portion 22 is coated with the conversion coating, such as a calcium-modified zinc phosphate conversion coating. As stated above, the conversion coating provides some surface roughness and increases the surface area of the steel cylindrical portion 22. Next, the adhesive, such as organosilane coupling agent, is applied over the conversion coating. As stated above, the conversion coating helps carry the adhesive on the metal cylindrical portion 22 and allows for some mechanical interlocking between the elastomer and the metal cylindrical portion 22.

After the elastomer and the cylindrical portion 22 formed of metal material are prepared, the method typically includes coupling the elastomer to the cylindrical portion 22 at a temperature of at least 100° C., or at least 150° C., or at least 180° C., such as by compression or injection molding, and without a curing step after the elastomer is coupled to the piston 20.

For compression molding, the elastomer coupled to the cylindrical portion 22 is placed in a compression molding press. The cylindrical portion 22 is placed in an open mold, and the uncured elastomer prep is placed on the cylindrical portion 22 in the mold. The location of the elastomer on the cylindrical portion 22 may vary, depending on the dimensions of the cylindrical portion 22 and the intended application of the piston 20 in the automatic transmission. Next, the method includes closing the molding press and exposing the cylindrical portion 22 and elastomer to a temperature of at least 100° C., or at least 150° C., or at least 180° C., and a high pressure. In the example method, the cylindrical portion 22 and elastomer are exposed to a temperature reaching about 190° C. in the molding press. The elastomer completes vulcanization or curing in the molding press, which occurs after enough time has passed and a high enough temperature has been reached. After the elastomer is cured, the molding press is opened. The time elapsed from closing the press to opening the press is typically two to five minutes, but can be more or less, depending on the temperature of the molding press, the chemical reaction rate of the particular batch of elastomer, and the thickness of the elastomer and cylindrical portion 22 being molded. The elastomer becomes chemically bonded to the cylindrical portion 22 when curing or vulcanization occurs in the compression mold. After the vulcanization occurs, the molding press is opened and the bonded piston 20 is removed from the press to cool for further processing.

Alternatively, instead of the compression molding process, the method can include an injection molding process for coupling the elastomer to the cylindrical portion 22. In this case, the cylindrical portion is placed in a mold of an injection molding machine. The elastomer is formed into granules. The elastomer granules are fed into a hopper of the injection molding machine, forced into the mold, and coupled to the cylindrical portion in the mold. The elastomer cools and hardens to the cylindrical portion, and is then removed from the mold for further processing.

As stated above, the elastomer cures during the coupling step and achieves sufficient cross-linking, strength, and other desirable physical and chemical properties. The curing step includes exposing the elastomer and the cylindrical portion to a temperature of at least 100° C. continuously for a single period of time. After the coupling step, but before using the piston 20 in an automotive application, the piston 20 is maintained at a temperature less than 100° C., preferably less than 20° C. The method does not include a post or second curing step, after the elastomer is coupled to the cylindrical portion, before using the piston 20 in an engine application. The piston 20 is not subject to a post curing step, which would typically include exposing the elastomer and cylindrical portion to a temperature of at least 100° C. for a second period of time.

As stated above, the cross-lining of the elastomer is substantially completed during the coupling step, which provides the elastomer with strength and other physical properties sufficient for use in an automotive application, such as automatic transmission. During the coupling step, the methyl acrylate, the ethylene, and the cure site monomer of the ethylene-acrylic polymer react with the curing agent, such as hexamethylene diamine, to provide amide cross-links in the elastomer. In one embodiment, when hexamethylene diamine is used as the curing agent, the following Mechanism 1 occurs during the coupling step to form the amide cross-links.

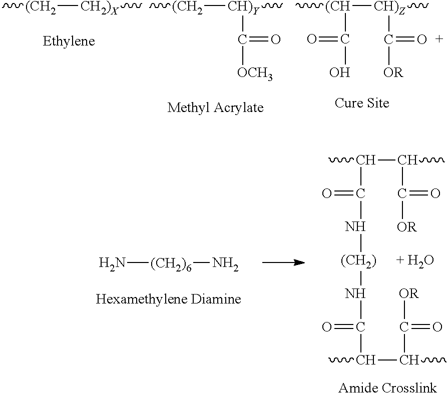

wherein X, Y, and Z are independent selected from an integer ranging from 1 to 1,000,000; and each R is independently selected from a group comprising hydrogen or a hydrocarbon chain of any length. After the elastomer and the cylindrical portion 22 formed of metal material are prepared, the method typically includes coupling the elastomer to the cylindrical portion 22 at a temperature of at least 100° C., or at least 150° C., or at least 180° C., such as by compression or injection molding, and without a curing step after the elastomer is coupled to the piston 20.

A sufficient cross-link density is achieved when the amide cross-links between the polymer chains are formed during the coupling step. The process of forming the elastomer includes the cross-linking in an amount sufficient to provide about 70% to 90%, typically 80% of the elastomer's potential tensile strength, without a post curing step. The strength of the elastomer's potential tensile strength, without a post curing step. The strength of the elastomer without a post curing step is sufficient for use in an automatic transmission. The additional strength that could be provided during a post curing step is not required. For example, the elastomer formed without the post curing step may have a tensile strength of 13 MPa, and the potential tensile strength that could be achieved with a post curing step is 15.6 MPa.

After coupling the elastomer to the cylindrical portion, such as by one of the molding processes described above, the elastomer is trimmed to a desired shape. For example, the piston 20 may have portions of the elastomer, such as lips, extending past the cylindrical portion, which are trimmed to align with the edges of the cylindrical portion. A trimming cell is typically used to trim the lips of the elastomer. After trimming the elastomer, additional hardware, such as pins, springs, and check valves, may be added to the piston 20, depending on the application of the piston 20. After adding the additional hardware, if any, the piston 20 is packaged for shipment to the customer.

As disclosed in the prior art, methods of forming a bonded piston typically include an oven post curing step after coupling or molding rubber to a metal piston. As alluded to above, a post curing would typically includes a second curing step, in addition to the curing that occurs during the coupling step. The post curing step would typically take place in an oven or in the presence of another heat source, after the elastomer is coupled to the piston 20. Post curing is typically conducted in an oven at a temperature of at least 100° C., or at least 150° C., and typically about 180° C., for a period of several hours, typically about four hours.

However, the piston 20 of the present invention is formed without an oven post curing step. The method does not include curing by an intentionally provided source of heat after the elastomer is coupled to the cylindrical portion. The method of the present invention typically includes maintaining the piston 20 at ambient temperature after coupling the elastomer to the cylindrical portion. If any post curing or additional curing of the elastomer occurs after the coupling step and before the piston 20 is used in an automotive application, that curing occurs at ambient temperature, or at a temperature less than 100° C., preferably less than 40° C.

Experiment 1

An experiment was conducted to test certain physical properties of the elastomer of Table 1. The physical properties tested were those typically relevant to elastomers bonded the metal pistons 20 of automatic transmissions. Such properties oftentimes must meet automotive industry specifications. The tests, procedures, and corresponding test results are listed in Table 2.

TABLE 2

| Test | Procedure | Results |
|---|---|---|
| As Received - Specific Gravity (Z5) | | 1.27 |
| As Received - Hardness (Z1) | ASTM D2240 | 79 |
| As Received - Tensile Strength (Mpa) | ASTM D412 | 13.3 |
| As Received - Ultimate Elongated (%) | ASTM D412 | 217 |
| As Received - Tensile modulus at 100% Elongation (Z6) | ASTM D412 | 8.1 |
| Dry Heat Resistance, 70 Hrs/150° C. - Durometer A change (points) | ASTM D573 | 9.6 |
| Dry Heat Resistance, 70 Hrs/150° C. - Tensile Strength change (%) | ASTM D573 | 19 |
| Dry Heat Resistance, 70 Hrs/150° C. - Elongation change (%) | ASTM D573 | −27 |
| IRM #901 Oil, 70 Hrs/150° C. - Durometer Change (points) | ASTM D471 | 6 |
| IRM #901 Oil, 70 Hrs/150° C. - Tensile Change (%) | ASTM D471 | 23 |
| IRM #901 Oil, 70 Hrs/150° C. - Elongation Change (%) | ASTM D471 | −18 |
| IRM #901 Oil, 70 Hrs/150° C. - Volume Change (%) | ASTM D471 | −3.7 |
| IRM #901 Oil, 70 Hrs/150° C. - Decomposition or Tackiness | ASTM D471 | Pass |
| IRM #903 Oil, 70 Hrs/150° C. (Z3) - Durometer Change (points) | ASTM D471 | −23 |
| IRM #903 Oil, 70 Hrs/150° C. (Z3) - Tensile Change (%) | ASTM D471 | −1 |
| IRM #903 Oil, 70 Hrs/150° C. (Z3) - Elongation Change (%) | ASTM D471 | −18 |
| IRM #903 Oil, 70 Hrs/150° C. (Z3) - Volume Change (%) | ASTM D471 | 38.8 |
| IRM #903 Oil, 70 Hrs/150° C. (Z3) - Decomposition or Tackiness | ASTM D471 | Pass |
| Compression Set, 70 Hrs/150° C. (Z4) - Piled Up Specimens | ASTM D395 | 73.6 |
| Fluid Aging, OEM Factory Fill Automatic Transmission Fluid, 70 Hrs/ | N/A | −2.8 |
| 150° C. - Durometer Change (points) | | |
| Fluid Aging, OEM Factory Fill Automatic Transmission Fluid, 70 Hrs/ | N/A | 18.8 |
| 150° C. - Tensile Change (%) | | |
| Fluid Aging, OEM Factory Fill Automatic Transmission Fluid, 70 Hrs/ | N/A | −24.2 |
| 150° C. - Elongation Change (%) | | |
| Fluid Aging, OEM Factory Fill Automatic Transmission Fluid, 70 Hrs/ | N/A | 6.3 |
| 150° C. - Volume Change (%) | | |
| Fluid Aging, OEM Factory Fill Automatic Transmission Fluid, 1008 Hrs/ | N/A | 4 |
| 150° C. - Durometer Change (points) | | |
| Fluid Aging, OEM Factory Fill Automatic Transmission Fluid, 1008 Hrs/ | N/A | 26 |
| 150° C. - Tensile Change (%) | | |
| Fluid Aging, OEM Factory Fill Automatic Transmission Fluid, 1008 Hrs/ | N/A | −37 |
| 150° C. - Elongation Change (%) | | |
| Fluid Aging, OEM Factory Fill Automatic Transmission Fluid, 1008 Hrs/ | N/A | −6.8 |
| 150° C. - Volume Change (%) | | |
| Torque, Rheometer, 240 minutes - (inches/pound) | ASTM D5289 | 29 |
| Solvent Swell Index (%) | | 169 |
| Life Expectancy, 590 psi (cycles to failure) | | 1,711 |
| Wear Rate | | 7-49% less |
| | | than with |
| | | post cure |

The test results of Experiment 1 indicate the elastomer, formed without a post curing step, is suitable for use in an automatic transition.

Experiment 2

A second experiment was conducted to compare certain physical properties of the elastomer of Table 1, formed without a post curing step, to the physical properties of a comparative elastomer, formed with a post curing step.

Experiment 2 included coupling the elastomer of Table 1 to a piston 20 in a compression mold. During the step of coupling the elastomer of Table 1 to the piston 20, Mechanism 1 occurs to form the amide cross-links of the elastomer.

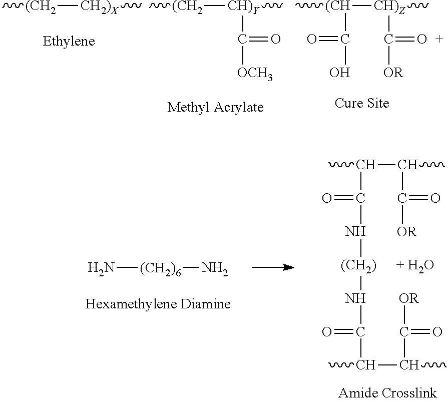

wherein X, Y, and Z are independently selected from an integer ranging from 1 to 1,000,000; each R is independently selected from a group comprising hydrogen or a hydrocarbon chain of any length. The elastomer of Table 1 was then tested, without a post curing step.

Experiment 2 also included coupling the comparative elastomer to the piston in a compression mold. At that point, the comparative elastomer had the same composition as Inventive Table 1, including the amide cross-link. However, after the compression mold, the comparative elastomer was subject to a post curing step. The comparative elastomer coupled to the piston was placed in a curing oven a temperature of about 180° C. and maintained at that temperature for 4 hours.

During the post curing step, the amide cross-links slowly rearranged to imide cross-links according to the following Mechanism 2:

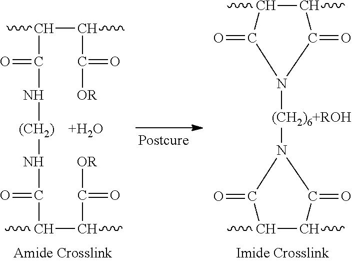

wherein each R is independently selected from a group comprising hydrogen or a hydrocarbon chain of any length. The post-cured comparative elastomer was then ready to be tested.

After the post curing step, the tensile strength, tensile modulus, torque, solvent index, wear rate, and life expectancy of the post-cured elastomer were tested, according to the test procedures described above. Table 3 includes a comparison between the physical properties of elastomer formed without the post curing step and the comparative elastomer formed with the post curing step.

TABLE 3

| | | With Post |
|---|---|---|
| Test | Without Post Cure | Cure |
| As Received - Tensile Strength (Mpa) | 13 | 16 |
| As Received - Tensile modulus | 8 | 12 |
| at 100% Elongation (Z6) | | |
| Torque, Rheometer, 240 minutes - | 29 | 33 |
| (inches/pound) | | |
| Solvent Swell Index, 72 hrs, 25° C. (%) | 169 | 176 |
| Life Expectancy (cycles to failure) | 1,711 | 238 |
| Wear Rate | 7-49% less than | |
| | with post cure | |

The solvent swell index and torque test results of Experiment 2 indicate that the cross-link density of the elastomer does not significantly increase during the post curing step. The torque test indicates the elastomer only experiences a 14% increase during the post curing step. Experiment 2 also indicates 80% of the elastomer tensile strength and 67% of the tensile modulus is achieved during the coupling step, such as the compression molding. The cross-link density, tensile strength, and tensile modulus achieved without the post curing step provides the elastomer that is sufficient for use in automatic transmission applications.

The life expectancy test was conducted using an extended duration engine test at a pressure of 590 psi. A high pressure stroker was used to determine the number of cycles until failure. The elastomer of Table 1 reached 1,711 cycles until failure, while the comparative elastomer reached only 238 cycles until failure. Thus, Experiment 3 indicated the elastomer of Table 1 had a life expectancy about seven times greater than the life expectancy of the comparative elastomer. Several wear rate tests were also conducted and indicated that the elastomer of Table 1 had about 7% to 49% less wear than the comparative elastomer.

Obviously, many modifications and variations of the present invention are possible in light of the above teachings and may be practiced otherwise than as specifically described while within the scope of the invention.

1. A piston for use in an automatic transmission, comprising:
a cylindrical portion formed of a metal material,
an elastomer coupled to said cylindrical portion,
said elastomer including an ethylene-acrylic polymer in an amount of 25 wt. % to 75 wt. %, based on the total weight of said elastomer,
said ethylene-acrylic polymer including methyl acrylate in an amount of 40 wt. % to 70 wt. % and an ethylene monomer in an amount of 20 wt. % to 60 wt. %, based on the total weight of said ethylene-acrylic polymer,
said elastomer including a curing agent in an amount of at least 0.5 wt. %, based on the total weight of said elastomer, and
said elastomer being cured by exposing said elastomer to a temperature of at least 100° C. continuously for a single period of time and being cured without exposing said elastomer to a temperature of at least 100° C. continuously for a second period of time.

2. The piston claim 1 wherein said piston is formed without a post curing step after said elastomer is coupled to said cylindrical portion.

3. The piston of claim 1 wherein said elastomer includes amide cross-links.

4. The piston of claim 1 wherein said elastomer includes imide cross-links in an amount of 0% to 5%, based on the total amount of cross-links of the elastomer.

5. The piston of claim 1 wherein said ethylene-acrylic polymer includes a cure site monomer in an amount up to 10 wt. %, based on the total weight of said ethylene-acrylic polymer.

6. The piston of claim 5 wherein said cure site monomer of said ethylene-acrylic polymer has a chemical structure of 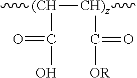
wherein X, Y, and Z are independently selected from an integer ranging from 1 to 1,000,000; and each R is independently selected from a group comprising hydrogen or a hydrocarbon chain of any length.

7. The piston of claim 1 wherein said curing agent includes hexamethylene diamine.

8. The piston of claim 1 wherein said ethylene-acrylic polymer includes said methyl acrylate in an amount of 50 wt. % to 60 wt. %, said ethylene monomer in an amount of 35 wt. % to 50 wt. %, and a cure site monomer being acidic in an amount of 0.5 wt. % to 5 wt. %, based on the total weight of said ethylene-acrylic polymer.

9. The piston of claim 1 wherein said elastomer is cured at a temperature of at least 100° C. for the single period of time.

10. The piston of claim 1 wherein said elastomer is cured while being coupled to said cylindrical portion.

11. The piston of claim 1 wherein said elastomer includes a tensile strength of 70% to 90% of the potential tensile strength of said elastomer.

12. The piston of claim 1 including a conversion coating disposed on said cylindrical portion, an adhesive disposed on said conversion coating, and said elastomer disposed on said adhesive.

13. The piston of claim 1 wherein said cylindrical portion presents a circumference and includes at least one groove extending axially into and around said circumference of said cylindrical portion.

14. The piston of claim 1 wherein said cylindrical portion includes a plurality of cutouts extending radially into said cylindrical portion.

15. The piston of claim 1 wherein said elastomer includes said ethylene-acrylic polymer in an amount of 35 wt. % to 65 wt. %, said curing agent in an amount of or 0.5 wt. % to 5 wt. %, wherein said curing agent includes hexamethylene diamine, a filler in an amount of 30 wt. % to 50 wt. %, and amide cross-links.

16. A method of forming a piston for use in an automatic transmission comprising:
providing an elastomer including an ethylene-acrylic polymer in an amount of 25 wt. % to 75 wt. % and a curing agent in an amount of at least 0.5 wt. %, based on the total weight of the elastomer, wherein the ethylene-acrylic polymer includes methyl acrylate in an amount of 40 wt. % to 70 wt. % and ethylene monomer in an amount of 20 wt. % to 60 wt. %, based on the total weight of the ethylene-acrylic polymer,
coupling the elastomer to a cylindrical portion formed of a metal material, and
said coupling step including curing the elastomer, wherein said curing includes exposing the elastomer to a temperature of at least 100° C. continuously for a single period of time and without exposing the elastomer to a temperature of at least 100° C. continuously for a second period of time.

17. The method of claim 16 including no post curing step after said coupling step.

18. The method of claim 16 wherein said curing includes forming amide cross-links in said elastomer.

19. The method of claim 16 wherein said curing the elastomer includes forming imide cross-links in an amount of 0% to 5%, based on the total amount of cross-links of the elastomer.

20. The method of claim 16 wherein said curing is at a temperature of at least 100° C. for the single period of time.
